(19) United States
(12) Patent Application Publication
(10) Pub. No.: US 2014/0052590 A1
(43) Pub. Date: Feb. 20, 2014

(54) Business Auditing System And Method

(71) Applicant: Besar Perdja, Glendale, NY (US)

(72) Inventor: Besar Perdja, Glendale, NY (US)

(21) Appl. No.: 13/586,129

(22) Filed: Aug. 15, 2012

(51) Int. Cl. G06Q 40/00

(52) U.S. Cl. CPC G06Q 40/10
USPC 705/30

(57) ABSTRACT

A system or method for auditing fixed rate bond securities classified as held-to-maturity in the financial statements comprising an auditing/accounting process flow which comprises determining whether the actual cost is higher than the par value; whether the book adjusted carrying value (BACV) is higher than said par value; and whether there is a red flag for a previous Other Than Temporary Impairment (OTTI). The system or method uses a series of logical tests to determine whether the fixed rate bond securities reported in the financial statements are undervalued or overvalued. The auditing/accounting method process flow of the present invention is better than the existing practice because it is able to go through logical tests for each and every fixed rate bond security.

### BACKGROUND OF THE INVENTION

1. Field of the Invention

This invention relates generally to a business system and method, and more particularly to a business auditing system and method that can find red flags for financial fraud, errors and omissions.

2. Description of Related Art

The key objectives for auditing investments are to gather sufficient appropriate evidence of existence, valuation, impairment, and classification and disclosure in the financial statements.

The existence assertion addresses whether investments exist at a given date, and whether recorded transactions have occurred during a given period. When a client has material amounts of investments or marketable securities held by others, normally an auditor would confirm the investments held by the trustee, obtain a certified detailed statement of activity from the trustee, and determine that transactions reported by the trustee have been recorded properly by the client, obtain a SSAE 16—SOC 1 Type II service auditor's report.

The valuation assertion addresses whether the amounts reported for investments in the financial statements through measurement or disclosure were determined in conformity with GAAP. Auditors design the testing to evidence corroborating the fair value from various sources. For marketable securities and investments, although confirmations may provide some evidence of fair value, some auditors acknowledge that simply receiving a confirmation from a third party does not in and of itself constitute adequate evidence with respect to the valuation assertion. Accordingly some auditors make use of third-party pricing services and internal specialists to develop their own estimate of fair value and review assumptions of the inputs used to value certain investments. Auditors obtain evidence about the cost of investments for investments carried at cost or amortized cost. The procedures might include: inspecting documentation indicating the purchase price of the security, confirming with the issuer or custodian, and, recalculating the amortization.

The completeness assertion addresses whether all invested assets are reported by the client. Auditor reconciles all material investments reports provided by the trustee to the trial balance.

When an auditor reviews the appropriateness of the classification of an investment, including alternative investments, the auditor considers the classifications defined by FASB Accounting Standards Codification ASC 320, Investments—Debt and Equity Securities.

The classification and measurement provisions of ASC 320 investments are as follows:
Debt securities that the company has the positive intent and ability to hold to maturity are classified as held-to-maturity securities and reported at amortized cost.
Debt and equity securities that are bought and held principally for the purpose of selling them in the near term are classified as trading securities and reported at fair value, with unrealized gains and losses included in earnings.
Debt and equity securities not classified as either held-to-maturity securities or trading securities are classified as available-for-sale securities and reported at fair value, with unrealized gains and losses excluded from earnings and reported in other comprehensive income.

In evaluating management's intent related to an investment, auditors consider whether investment activities corroborate or conflict with management's state intent. In doing so, auditors examine evidence such as written and approved records of investment strategies, records of investment activities, instructions to portfolio managers and minutes of meetings of the board of directors or the investment committee. Auditors also obtain written representations from management confirming that they have properly classified securities as held-to-maturity, trading, or available-for-sale, and, with respect to held-to-maturity debt securities, that management has the intent and the company has the ability to hold such investments to maturity.

Listed are some of the procedures that auditors use to test investments for errors, omission or fraud:
One procedure is bank confirmations. A request for confirmation is sent to the custodian bank. The custodian bank will confirm what investments are owned by the client. This confirmation by the bank provides assurance to the auditor for the existence of the investments in the client's bank account.
Another form of debt security investment testing is called interest income reasonable testing. This test compares the percentage change of the interest earned during the current 12 months from debt security investments, to the interest earned from debt security investments during the previous 12 months.

### Example

Investment Interest Earned during 2010 is $1,000,000. Investment Interest earned during year 2011 is $1,020,000. The reasonable test would be ($1,020,000-$1,000,000)/$1,000,000=2% yearly increase in investment interest income. The auditor would take into judgment company specific circumstances, economic circumstances and market interest rates trend in concluding that a 2% increase in interest income is reasonable.
Usually the investments are kept with an investment manager or custodian that keeps track of the investment portfolio on behalf of the client, it reports to the client the cost, purchase dates, fair value, book value, par value, maturity, coupon, how often is the coupon paid and description of the security and other accounting attributes. The auditor of the client would request from the custodian bank or investment manager, a SSAE 16—SOC 1 Type 2 report. The auditor uses this report to place reliance on the custodian banks system or the investment manager's system. The report describes various tests done on the investment manager's system and custodian bank's system, and hopefully has no exceptions noted. Therefore the auditor of the client would place reliance on this SSAE 16—SOC1 Type 2 report to provide assurance that the investment manager or bank custodian system that holds the investments for the client works properly and has effective controls around the investment portfolio. So in summary the auditors obtain a SSAE 16—SOC 1 Type 2 report and inspect the report for exceptions relating to the valuation of investments and the accuracy, occurrence and completeness of the gain/losses, amortization and interest amounts.
Auditors also test the fair value pricing of the securities in the investment portfolio. Auditors make use of certain software that picks up the CUSIP number of each security in the investment portfolio and shows up the security's corresponding fair market value. This process uses pricing data feeds from companies such as Bloomberg, Reuters, Fincad and IDC. Unlike trading securities and available-for-sale securities, for held-to-maturity investments Book Adjusted Carrying Value is what will show in the Balance Sheet, therefore the Fair Value confirmation is not as critical for held-to-maturity. However the fair market value of the held-to-maturity securities does have to show as a disclosure to the financial statements but it will not appear in the Balance Sheet.
Sample Testing: For investments purchased at a premium or discount, since the previous audit, auditors select a sample and test the investment book value, by performing the following steps:

1. They determine the method used to calculate and record amortization of premiums and accretion of discounts (Straight Line Method or Effective Interest Method); and

2. Determine the gross amount of premium or discount at purchase date (Cost minus Par);

3. Determine period of maturity or call date (amortization of the premium or discount stops on maturity or call date);

4. Calculate the amount of premium or discount remaining to be amortized or accreted (so basically calculate for the selected sample the discount or premium remaining);

5. Determine that book value is properly reflected in the General Ledger (after calculating the remaining premium you add the remaining premium to the Par Value to get the Book Adjusted Carrying Value or after calculating the remaining discount you subtract the remaining discount from the Par Value to get the Book Adjusted Carrying Value and then compare and match to what the Book Adjusted Carrying Value is in the General Ledger);
Integrated Test Facility: When reviewing the accounting controls of an investment advisor or custodian, an Integrated Test Facility (“ITF”) gets established. The use of an ITF is judgmental based on efficiency and effectiveness to test certain types of transactions processed through the custodian bank's applications. In an ITF, test transactions are processed through the production processing application, or a test environment that mirrors production in all material aspects, using the same data entry and processing procedures used by the custodian bank's personnel. Auditors would utilize an ITF to recalculate the amortization/accretion based on the debt security transaction records.

However, the current auditing methods for fixed rate bond securities classified as held-to-maturity do not pick up all of the material or immaterial misstatements for the held-to-maturity securities. The current methods, for auditing fixed rate bond securities classified as held-to-maturity, include taking a sample size of the debt securities and test the accuracy of the Book Adjusted Carrying Value for the selected sample. This process is not great at picking up all small errors and omissions that might not be material individually but might be material in the aggregate. Unlike the auditing practice of confirming the fair market value of fixed rate bond security investments through data feeds from Bloomberg, Reuters, Fincad and IDC, the current auditing methods for fixed rate bond securities classified as held-to-maturity, do not test every single fixed rate bond security that is classified as held-to-maturity.

To the inventor's best knowledge there is no auditing tool that can check the Book Adjusted Carrying Value of each and every fixed rate bond security for errors, omissions or fraud resulting from an undervaluation or an overvaluation of the Book Adjusted Carrying Value of each security.

Therefore, there needs a better auditing method that can find red flags, errors and omissions that would affect a company's financial statements, mainly balance sheet but the errors would carry on into the income statement as well as the cash flow statement (funds flow statement).

### SUMMARY OF THE INVENTION

The primary object of the auditing system or method according to the present invention is to find red flags, errors and omissions that would affect a company's financial statements, mainly balance sheet but the errors would carry on into the income statement as well as the cash flow statement (funds flow statement).

The present invention provides a system or method for auditing fixed rate bond securities classified as held-to-maturity in the financial statements comprising an auditing/accounting process flow which includes:

identifying par value of said fixed rate bond securities;
identifying cost of said fixed rate bond securities;
identifying book adjusted carrying value of said fixed rate bond securities;
determining whether said cost is higher than or lower than or equal to said par value; and
determining whether said book adjusted carrying value is higher than or lower than or equal to said par value; and
determining whether there is a previous OTTI (Other Than Temporary Impairment) if said cost is not lower than said par value and said book adjusted carrying value is lower than said par value.

The auditor flags an audit alert for a reported undervaluation if said cost is higher than said par value, and said book adjusted carrying value is not higher than par value, and there is not a previous OTTI. The auditor flags an audit alert for a reported overvaluation if said cost is lower than said par value, and said book adjusted carrying value is not lower than par value. The auditor flags an audit alert for a reported undervaluation if said cost is equal to said par value, and said book adjusted carrying value is lower than par value, and there is not a previous OTTI. The auditor flags an audit alert for a reported overvaluation if said cost is equal to said par value, and said book adjusted carrying value is higher than said par value.

The inventor's auditing/accounting method process flow is better than the current practice because it is able to go through a logical test for each and every fixed rate bond security and provide further assurance that based on the logical test that the Book Adjusted Carrying Value is being reported appropriately, undervalued or overvalued and if there was any previous OTTI (Other Than Temporary Impairment). It is also a great tool to pick up immaterial undervaluation or immaterial overvaluations that could be material in the aggregate.

Moreover, the logical test can be achieved by using simple mathematical formula (equation) which any simple computer logistics (or software or program) can handle, such as Excel.

Therefore, this auditing/accounting method process flow is a computer implemented method which can help auditors to check each and every fixed rate bond security using computers and thus save a lot of time.

The auditing/accounting process flow of the present invention can be a part of a work-flow-enabled application and interface with other business auditing process flow of said work-flow-enabled application, such as calculating and determining the accuracy of the reported interest and amortization of premium or discount, and determining whether they are reported properly.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 illustrates a logical test #1 for a Premium Bond to determine whether a Premium Bond is reported undervalued.

FIG. 2 illustrates a logical test #2 for a Discount Bond to determine whether a Discount Bond is reported overvalued.

FIG. 3 illustrates a logical test #3 for a Par Bond to determine whether a Par Bond is reported overvalued or undervalued.

FIG. 4 illustrates a flow chart for a combined logical test to determine whether a fixed rate bond security is reported overvalued or undervalued.

FIG. 5 shows examples of overvaluation and undervaluation of Par Bonds where the Actual Cost for these securities is equal to the Par Value, according to the logical relation #3.

FIG. 6 shows examples of undervaluation of Premium Bonds where the Actual Cost for these securities is higher than the Par Value, according to the logical relation #1.

FIG. 7 shows examples of overvaluation of Discount Bonds where the Actual Cost for these securities is lower than the Par Value, according to the logical relation #2.

### DESCRIPTION OF THE PREFERRED EMBODIMENT

Certain fixed rate bond or zero coupon bond security investments such as U.S. Treasury Securities; U.S. government agency bonds; Municipal bonds; corporate bonds; convertible debt; that have an accounting classification as held-to-maturity securities have to be reported in the balance sheet using the amortized cost method (see ASC 320-10-25-1 C and see ASC 320-10-25-3). Even when a fixed rate bond security gets transferred from the available-for-sale classification in to the held-to-maturity classification, this idea works (ASC 320-10-55-24).

When an entity buys a fixed rate bond security, there is a Cost, Par Value and Book Adjusted Carrying Value attribute associated with the debt security. For held-to-maturity fixed rate bond securities, the Book Adjusted Carrying Value has to reflect the amortization of the initial premium or discount of the bond when first bought. The amortization of the premium or discount stops on the last coupon payment when the bond matures and the Par Value is paid.

A fixed rate bond security that was bought or transferred to held-to-maturity at a Premium (Cost of security was higher than Par Value), cannot have a Book Adjusted Carrying Value below Par Value, unless there was an Other Than Temporary Impairment (OTTI).

A fixed rate bond security that was bought or transferred to held-to-maturity at a Discount (Cost of the security was lower than Par Value), cannot have a Book Adjusted Carrying Value above Par Value.

A fixed rate bond security that was bought or transferred to held-to-maturity at Par Value (Cost of the security is equal to Par Value), cannot have a Book Adjusted Carrying Value above Par Value since this would cause an overvaluation of the fixed rate bond security. Also it cannot have a Book Adjusted Carrying Value below Par Value unless there was a previous Other Than Temporary Impairment (OTTI).

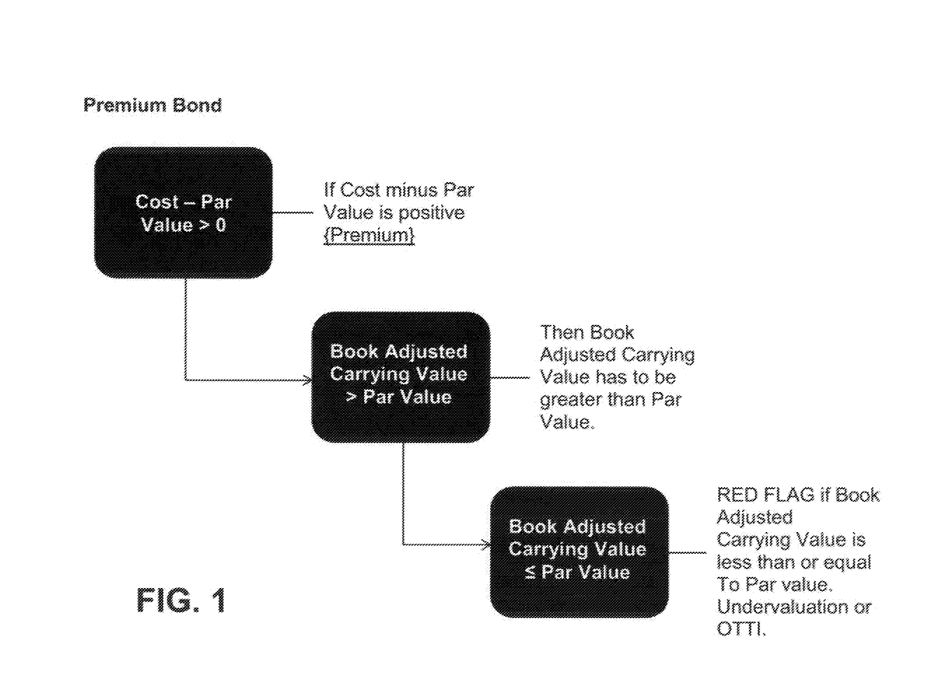

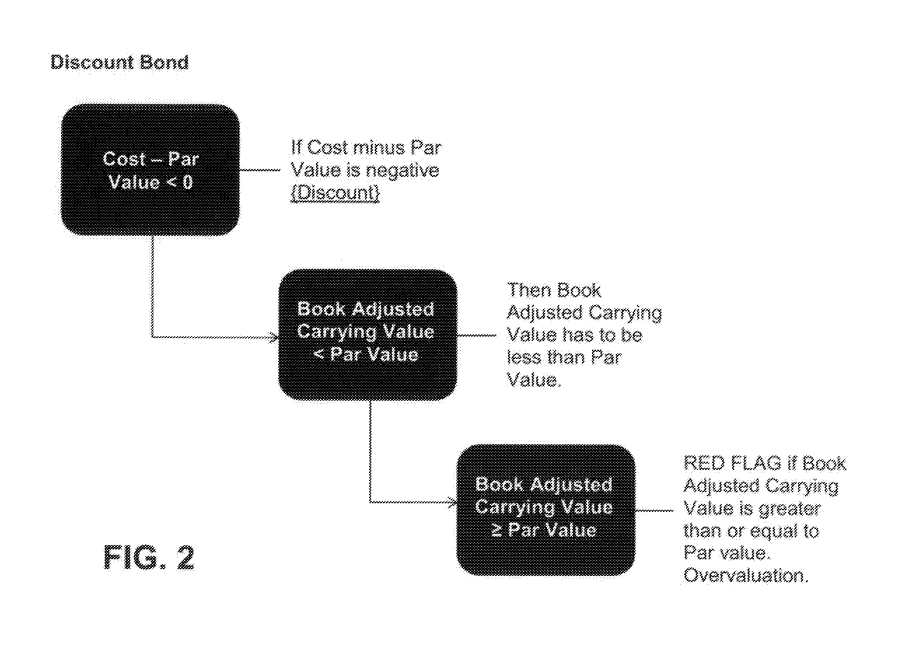

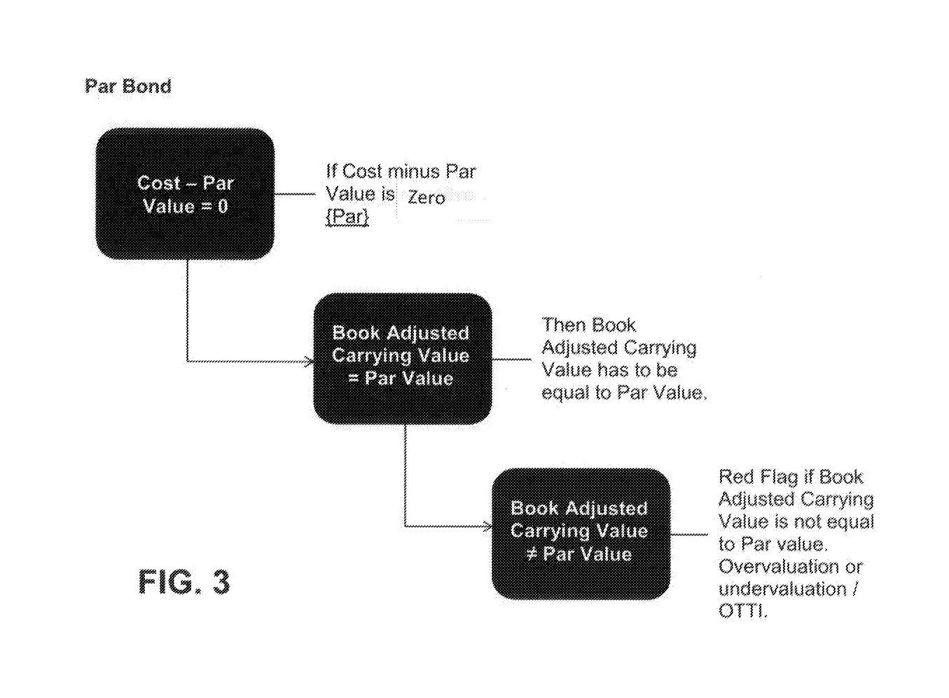

As a result, an auditing/accounting method process flow is developed by the inventor as illustrated in FIGS. 1-3 and explained below.

#1. If the below logical relationship is broken then we have a red flag for a previous Other Than Temporary Impairment (OTTI). If no previous OTTI had occurred then we have a red flag for a reported undervaluation. The debt security account would be undervalued and misreported.

Cost−Par Value=Positive (Premium Bond) then Book Adjusted Carrying Value>Par Value

#2. If the below logical relationship is broken then we have a red flag for fraud, error and omission (reported overvaluation). The debt security account would be overvalued and misreported.

Cost−Par Value=Negative (Discount Bond) then Book Adjusted Carrying Value<Par Value

#3. If the below logical relation is broken then we have a red flag for a previously taken Other Than Temporary Impairment (OTTI), or an overvaluation of the fixed rate bond security. If no previous OTTI had occurred then we have a red flag for an undervaluation.

Cost−Par Value=Zero (Cost=Par Value therefore Par Bond) then Book Adjusted Carrying Value=Par Value
If Cost−Par Value=Zero (Cost=Par Value) is true, and Book Adjusted Carrying Value<Par Value, then there either was a previously taken OTTI or the fixed rate bond security is being reported undervalued.
If Cost−Par Value=Zero (Cost=Par Value) is true, and Book Adjusted Carrying Value>Par Value, then the fixed rate bond security is being reported overvalued.

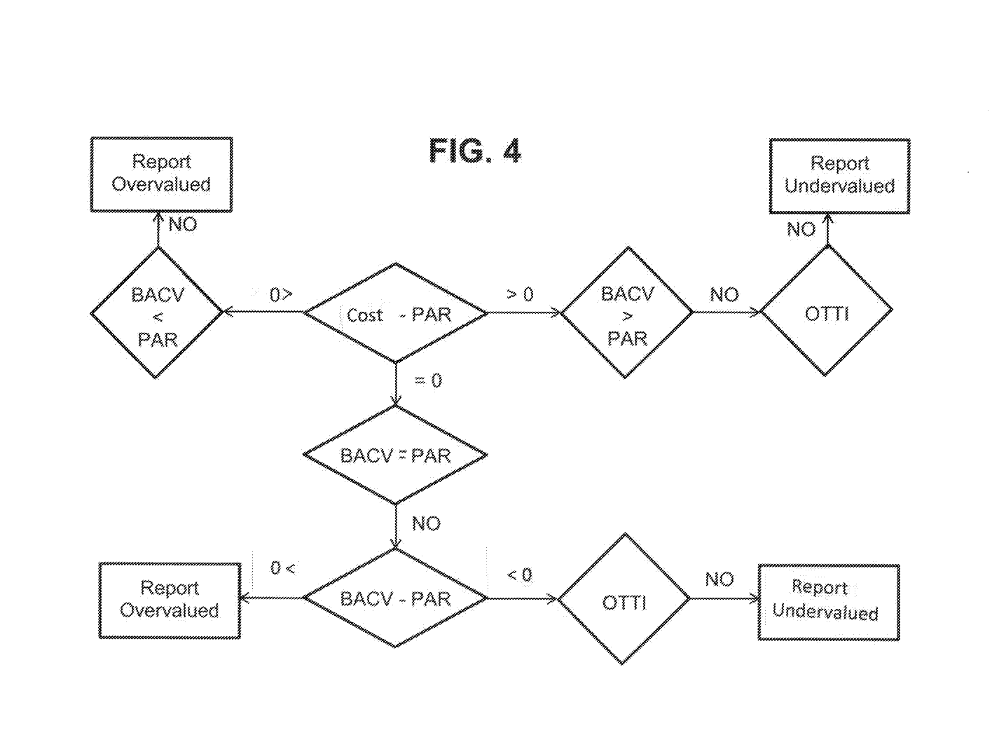

FIG. 4 shows a flow chart illustrates a series of logical tests to determine whether a fixed rate bond security is overvalued or undervalued.

Moreover, the logical test can be achieved by using any computer software (or program) that is able to perform mathematical calculation such as Excel and other software. Therefore, this auditing/accounting method process flow may be a part of a computer implemented business method or system or software which can help auditors to save a lot of time by visual inspection.

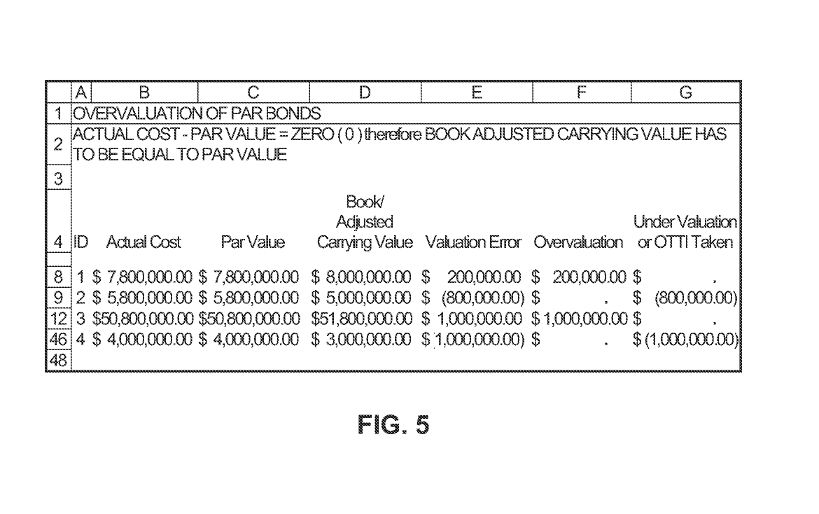

FIG. 5 (pages 3 of part 2) shows examples of Par Bonds of which the Actual Cost for these securities is equal to the Par Value. According to the logical relation #3, the Book Adjusted Carrying Value has to be equal to the Par Value. However, in these examples, the Book Adjusted Carrying Value is higher than the Par Value, the logical relation is broken. These fixed rate bond securities accounts are red flagged as overvalued or misreported

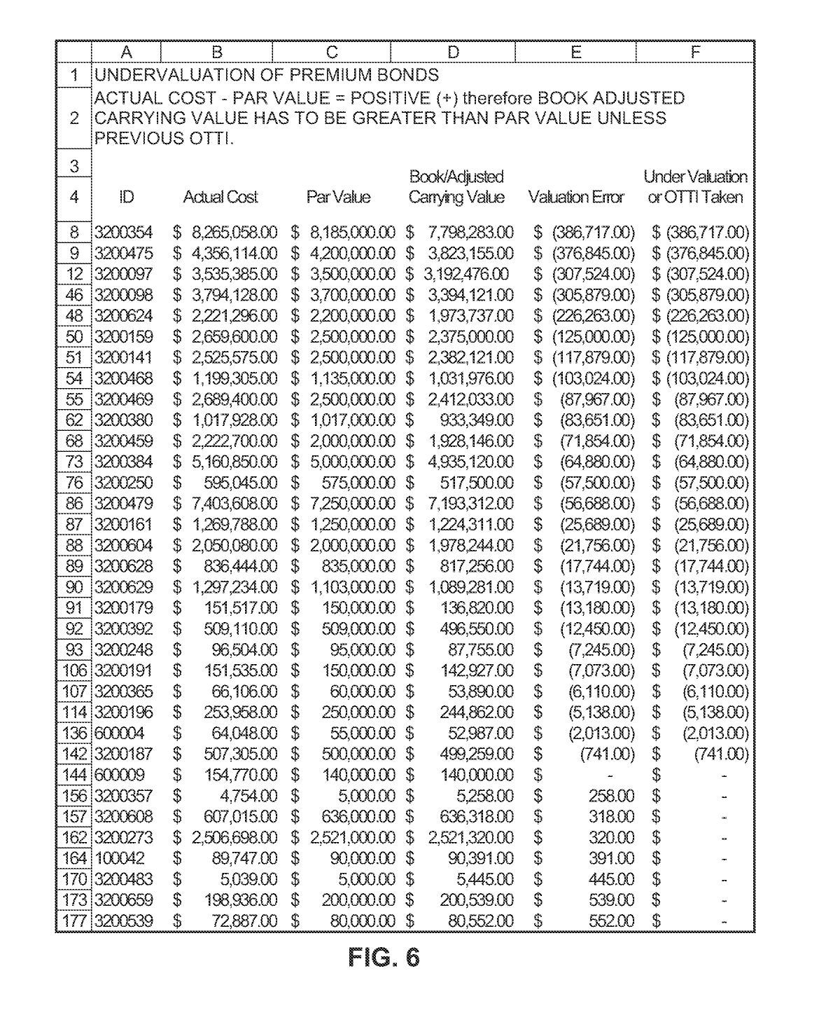

FIG. 6 (page 11 of part 2) shows examples of premium bond of which the Actual Cost for these securities is higher than the Par Value. According to the logical relation #1, the Book Adjusted Carrying Value has to be higher than the Par Value. However, in these examples, the Book Adjusted Carrying Value is not higher than the Par Value, the logical relation is broken. In addition, there is no previously occurred OTTI; therefore, these fixed rate bond securities accounts are red flagged as undervalued or misreported

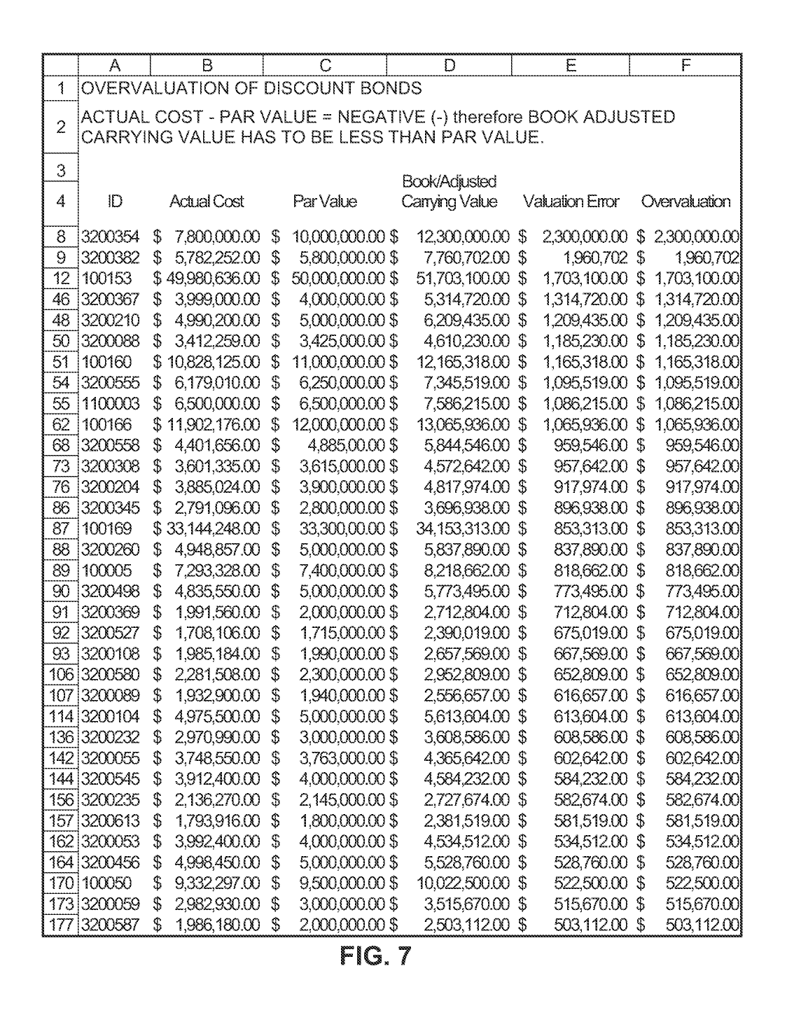

FIG. 7 (page 16 of part 2) shows examples of discount bond of which the Actual Cost for these securities is lower than the Par Value. According to the logical relation #2; the Book Adjusted Carrying Value has to be less than the Par Value. However, in these examples, the Book Adjusted Carrying Value is not less than the Par Value, the logical relation is broken. These fixed rate bond securities accounts are red flagged as overvalued or misreported

The auditing/accounting process flow of the present invention can be a part of a work-flow-enabled application and interface with other business auditing process flow of said work-flow-enabled application, such as calculating and determining the accuracy of the reported interest and amortization of fixed rate bond securities, and determining whether they are reported properly.

The business auditing system method may further comprising obtaining evidence about the cost of investments for investments carried at cost or amortized cost including inspecting documentation indicating the purchase price of the security, confirming with the issuer or custodian, and, recalculating the amortization.
While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system or method for auditing fixed rate bond securities classified as held-to-maturity in the financial statements comprising:
an auditing/accounting process flow comprising:
identifying par value of said fixed rate bond securities;
identifying cost of said fixed rate bond securities;
identifying book adjusted carrying value of said fixed rate bond securities;
determining whether said cost is higher than or lower than or equal to said par value; and
determining whether said book adjusted carrying value is higher than or lower than or equal to said par value.

2. The system or method for auditing fixed rate bond securities classified as held-to-maturity in the financial statements of claim 1 wherein said auditing/accounting process flow further comprising:
determining whether there is a red flag for a previous Other Than Temporary Impairment (OTTI) if said cost is higher than said par value, and said book adjusted carrying value is not higher than said par value, and
flagging an audit alert for a reported undervaluation if there is no said previous OTTI.

3. The system or method for auditing fixed rate bond securities classified as held-to-maturity in the financial statements of claim 1 wherein said auditing/accounting process flow further comprising:
flagging an audit alert for a reported overvaluation if said cost is lower than said par value, and said book adjusted carrying value is not lower than said par value.

4. The system or method for auditing fixed rate bond securities classified as held-to-maturity in the financial statements of claim 1 wherein said auditing/accounting process flow further comprising:
determining whether there is a red flag for a previous Other Than Temporary Impairment (OTTI) if said cost is equal to said par value, and said book adjusted carrying value is lower than said par value, and
flagging an audit alert for a reported undervaluation if there is no said previous OTTI.

5. The system or method for auditing fixed rate bond securities classified as held-to-maturity in the financial statements of claim 1 wherein said auditing/accounting process flow further comprising:
flagging an audit alert for a reported overvaluation if said cost is equal to said par value, and said book adjusted carrying value is higher than said par value.

6. The system or method for auditing fixed rate bond securities classified as held-to-maturity in the financial statements of claim 1 wherein determining whether said cost is higher than said par value can be achieved by using a mathematical formulation.

7. The system or method for auditing fixed rate bond securities classified as held-to-maturity in the financial statements of claim 1 wherein determining whether said book adjusted carrying value is higher than said par value can be achieved by using a mathematical formulation.

8. The system or method for auditing fixed rate bond securities classified as held-to-maturity in the financial statements of claim 1 wherein said auditing/accounting process flow can be carried out using a computer implemented software program or can be included in a computer implemented software program.

9. The system or method for auditing fixed rate bond securities classified as held-to-maturity in the financial statements of claim 1 may further comprising verifying whether said par value and cost are properly reported.

10. The system or method for auditing fixed rate bond securities classified as held-to-maturity in the financial statements of claim 1 wherein said auditing/accounting process flow can be a part of a work-flow-enabled application and interface with other business auditing process flow of said work-flow-enabled application.
